(19) United States
(12) Patent Application Publication
(10) Pub. No.: US 2011/0150344 A1
(43) Pub. Date: Jun. 23, 2011

(54) CONTENT BASED IMAGE RETRIEVAL APPARATUS AND METHOD

(75) Inventor: Keun Dong LEE, Daejeon (KR)

(73) Assignee: Electronics and Telecommunications Research Institute, Daejeon (KR)

(21) Appl. No.: 12/969,541

(22) Filed: Dec. 15, 2010

(30) Foreign Application Priority Data
Dec. 21, 2009 (KR) 10-2009-0127712

(51) Int. Cl. G06K 9/46; G06K 9/54

(52) U.S. Cl. 382/203; 382/305

(57) ABSTRACT

Disclosed are a content based image retrieval apparatus and a content base image retrieval method. The content based image retrieval apparatus includes: a query image converter converting an inputted query image to a black/white image and normalizing the size of the query image; a shape information extractor extracting a feature on the basis of brightness values in all pixels of the normalized black/white query image; and a shape descriptor configuring section configuring a shape descriptor for each pixel by using the feature.

### CROSS-REFERENCE TO RELATED APPLICATIONS

This application claims priority under 35 U.S.C. §119 to Korean Patent Application No. 10-2009-0127712, filed on Dec. 21, 2009, in the Korean Intellectual Property Office, the disclosure of which is incorporated herein by reference in its entirety.

### BACKGROUND OF THE INVENTION

1. Field of the Invention

The present invention relates to a content based image retrieval technology for overcoming limitations of a known text based image retrieval technology.

2. Description of the Related Art

A known text based image retrieval technology performs retrieval by depending on only a title of an image or meta data. In this case, since different file names or meta data may be given to the same image, a retrieval criterion is ambiguous and as a result, there is a limit to retrieve enormous images on the Internet.

In order to solve the problem, in recent years, active research is in progress in a content based image retrieval technology field. In the content based image retrieval technology, an image descriptor is created by using various visual features such as a color, texture, a shape, etc., of an image and a retrieval result is drawn comparing the similarity between various images by using the same. Since various visual features of an object in the image are completely the same in the same images and not largely different in similar images, it is possible to further improve retrieval accuracy.

Shape information among the visual features has a particularly important meaning. Humans can recognize features of an object by using only the shape information of the object. Further, since two images having a similar color histogram can express very different objects, it is effective to use the shape information in order to discriminate them. In the International Standard Organization (ISO)/the International Electrotechnical Commission (IEC) Joint Technical Committees (ISO/IEC JTC1), a shape descriptor is actively discussed in MPEG-7 and a plurality of technologies compete with each other for the standard. In a contour based shape descriptor using contour information of the object, a technology called CSS is set as the standard and in a region based shape descriptor using a distribution of brightness values for each region of the object, a 2D ART based descriptor is adapted as the standard while an MLEV, Zernike Moment based descriptor, the 2D ART based descriptor, etc. compete with each other. However, since all types of shape descriptors arranged above are technologies available only under a presumption that an input image is a binary image in which an object and a background are completely segmented, it is actually difficult to apply the descriptors to an actual retrieval related application.

Further, methods of acquiring the shape information without segmentation by using corner information and performing retrieval by using the shape information are proposed. However, a shape descriptor acquired by using corners of a limited number and peripheral areas thereof is not enough to represent all the images. For example, in the case in which there is no high-frequency component and a color and a brightness value are uniform, when a very small number of corners are detected and the shape descriptor is created by using the corners to be used for retrieval, an image completely different from an image to be retrieved may be retrieved, such that it is inefficient.

### SUMMARY OF THE INVENTION

The present invention is contrived to solve the problems. There is an object of the present invention to configure a shape descriptor without segmentation by using information of pixels in an image including corners and edges in the image and perform content based retrieval by using the shape descriptor.

The object of the present invention is not limited to the above-mentioned object and other undescribed objects will be apparently appreciated by those skilled in the art from the following descriptions.

According to an aspect of the present invention, there is a content based image retrieval apparatus that includes: a query image converter converting an inputted query image to a black/white image and normalizing the size of the query image; a shape information extractor extracting a feature on the basis of brightness values in all pixels of the normalized black/white query image; and a shape descriptor configuring section configuring a shape descriptor for each pixel by using the feature.

According to another aspect of the present invention, there is a content based image retrieval method that includes: extracting features of pixels configuring an inputted query image by using brightness values of the pixels; configuring shape descriptors of the pixels by using the features; and retrieving the image by using the shape descriptors.

According to yet another aspect of the present invention, there is a content based image retrieval method that includes: converting an inputted query image to a black/white image and normalizing the size of the query image; detecting a corner pixel, an edge pixel, and a general pixel among all pixels configuring the normalized black/white query image; extracting sectional features on the basis of brightness values of the corner pixel, the edge pixel, and the general pixel; extracting a global feature of the image from at least one of the corner pixel, the edge pixel, and the general pixel; and configuring a shape descriptor by using the sectional feature and the global feature.

Details of other embodiments are included in the detailed description and the accompanying drawings.

According to the exemplary embodiment of the present invention, since a shape descriptor is configured by using sufficient information without segmentation for a content based retrieval technology, an excessive algorithm performing speed is not required due to the segmentation and retrieval efficiency is not deteriorated due to the inaccurate segmentation.

Further, although a query image to be retrieved has no high-frequency component and a substantially uniform area, information on colors and brightness values of all pixels of the image is used to extract the shape descriptor, such that the retrieval efficiency is not deteriorated.

### BRIEF DESCRIPTION OF THE DRAWINGS

FIG. 1 is a block diagram for describing a content based image retrieval apparatus according to an exemplary embodiment of the present invention;

FIG. 2 is a flowchart for describing a content based image retrieval method according to an exemplary embodiment of the present invention;

FIGS. 3 and 4 are conceptual diagrams for describing a sectional shape information extractor of FIG. 1;

FIGS. 5A and 5B are conceptual diagrams for describing a global shape information extractor; and

FIGS. 6 and 7 are conceptual diagrams for describing a shape descriptor configuring section of FIG. 1.

### DETAILED DESCRIPTION OF THE PREFERRED EMBODIMENTS

Advantages and characteristics of the present invention, and methods for achieving them will be apparent with reference to embodiments described below in detail in addition to the accompanying drawings. However, the present invention is not limited to the exemplary embodiments to be described below but may be implemented in various forms. Therefore, the exemplary embodiments are provided to enable those skilled in the art to thoroughly understand the teaching of the present invention and to completely inform the scope of the present invention and the exemplary embodiment is just defined by the scope of the appended claims. Meanwhile, terms used in the specification are used to explain the embodiments and not to limit the present invention. Further, in this specification, a case in which one element is “connected to” includes both the other element one element is directly connected or coupled to the other element and both another element intervenes therebetween. In the specification, a singular type may also be used as a plural type unless stated specifically. “Comprises” and/or “comprising” used in the specification does not exclude existence or addition of one or more other components in the case of described components.

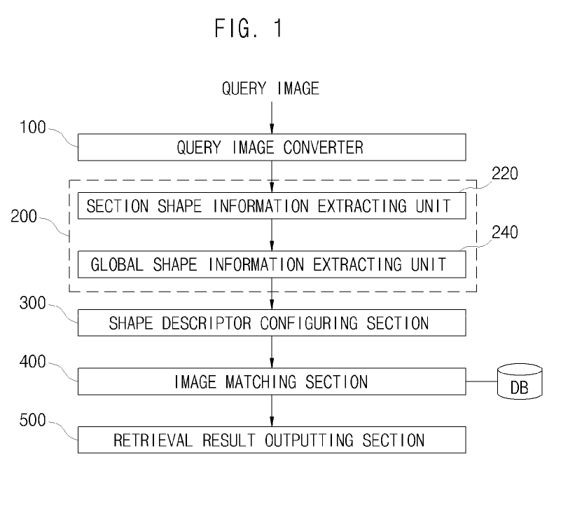

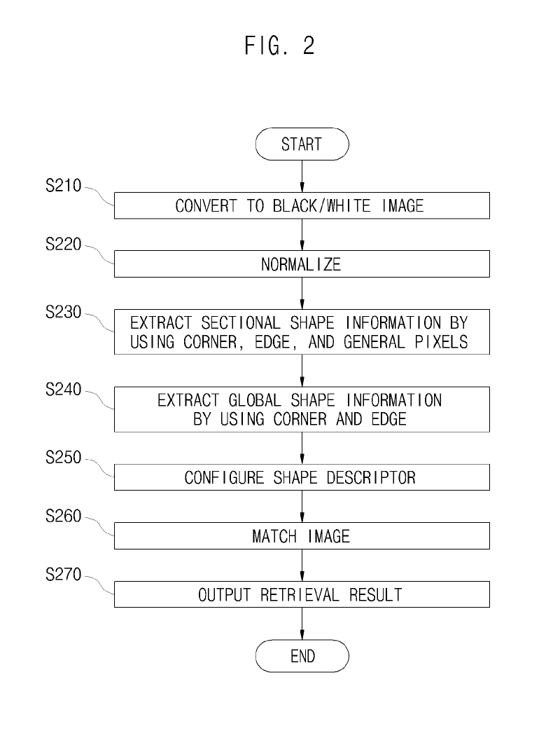

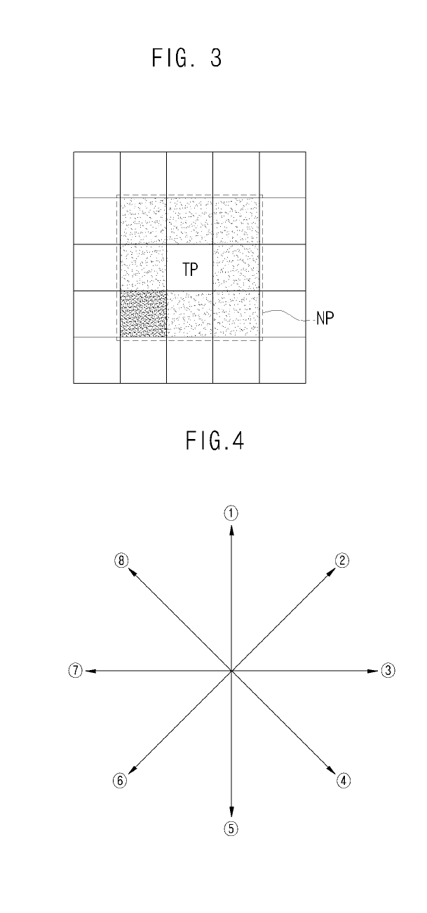

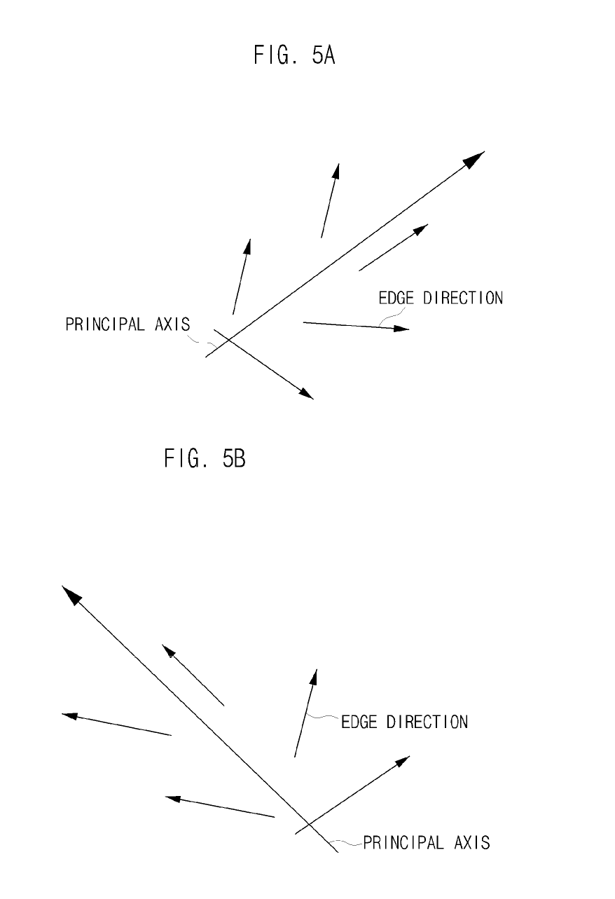

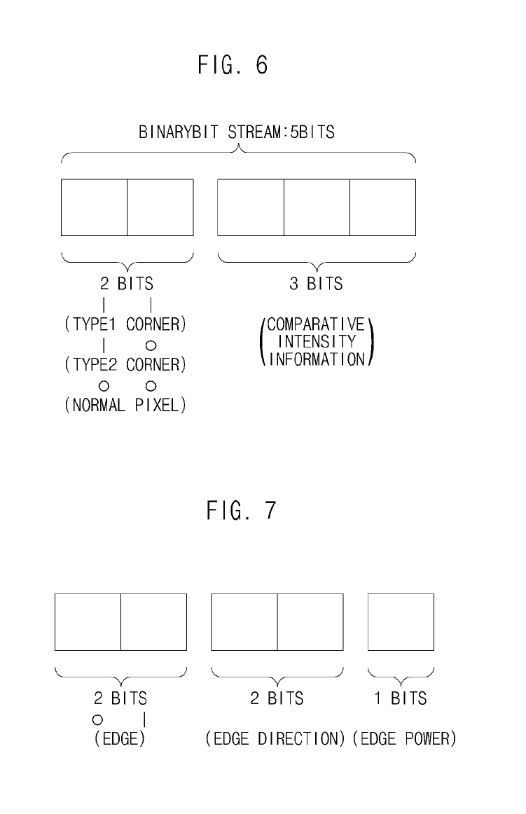

Hereinafter, an apparatus and a method for content based image retrieval according to an exemplary embodiment of the present invention will be described with reference to FIGS. 1 to 7. FIG. 1 is a block diagram for describing a content based image retrieval apparatus according to an exemplary embodiment of the present invention, FIG. 2 is a flowchart for describing a content based image retrieval method according to an exemplary embodiment of the present invention, FIGS. 3 and 4 are conceptual diagrams for describing a sectional shape information extractor of FIG. 1, and FIGS. 5A and 5B are conceptual diagrams for describing a global shape information extractor, FIGS. 6 and 7 are conceptual diagrams for describing a shape descriptor configuring section of FIG. 1.

Referring to FIG. 1, the content based retrieval apparatus 10 using a shape descriptor according to the exemplary embodiment of the present invention includes a query image converter 100, a shape information extractor 200, a shape descriptor configuring section 300, an image matching section 400, and a retrieval result outputting section 500. The shape information extractor 200 may include a sectional shape information extracting unit 220 and a global shape information extracting unit 240.

Specifically, the query image converter 100 converts an inputted query image into a black/white image (S210) and the size of the image is normalized to a fixed MXN size (S220). Since, for example, images in the web have various sizes, the query image converter 100 may normalize the sizes of the images to one size. However, the query image converter 100 may not be provided. For example, in the embodiment, although the shape information extractor 200 to be described below extracts features from the normalized black/white images, the shape information extractor 200 may extract the features from color values or brightness values by the colors in color images. In this case, the query image converter 100 may not convert the query image to the black/white image.

The shape information extractor 200 extracts features of pixels constituting the normalized black/white query image by using brightness values of the pixels. However, as described above, in the case in which the query image converter 100 is not provided or does not convert the query image to the black/white image, the shape information extractor 200 may extracts the features from the color values or the brightness values by the colors. Alternately, the shape information extractor 200 may extract the features by selecting some pixels in unnormalized query images by considering the size of the query image and a normal size in a query image having a predetermined size without extracting the features from the normalized images.

The shape information extractor 200 may include the sectional shape information extracting unit 220 and the global shape information extracting unit 240.

The sectional shape information extractor 220 compares the size of a brightness value of an information extraction target pixel with the size of a brightness value of an neighbor pixels adjacent to the information extraction target pixel, for example, the neighbor pixel surrounding the information extraction target pixel for all the pixels in the image to extract the number of neighbor pixels having brightness values larger than the information extraction target pixel or the number of neighbor pixels having brightness values smaller than the information extract target pixel as a feature of the information extraction target pixel.

Further, the sectional shape information extracting unit 220 may classify all pixels constituting the image into a corner pixel, an edge pixel, and a general pixel. For example, when a brightness of any one pixel markedly varies in one direction in comparison with the brightness of the neighbor pixel, the sectional shape information extracting unit 220 may classify (or detect) the corresponding pixel as the edge pixel. Alternately, when a brightness of any one pixel markedly varies in two or more direction in comparison with the brightness of the neighbor pixel, the sectional shape information extracting unit 220 may classify (or detect) the corresponding pixel as the corner pixel. The sectional shape information extracting unit 220 may classify the rest pixels other than the corner pixels and the edge pixels as the general pixel among the pixels constituting the image.

In addition, the sectional shape information extracting unit 220 may extract the feature of each pixel (alternately, sectional shape information) by using the brightness value of each pixel with respect to the corner pixel, the edge pixel, and the general pixel (S230). For example, the sectional shape information extracting unit 220 may extract the feature of each pixel by using brightness values of neighbor pixels adjacent to each of the corner pixel, the edge pixel, and the general pixel. As such, the sectional shape information extracting unit 220 may extract the sectional shape information in that it extracts the feature of each pixel.

As a detailed example, an operation of the sectional shape information extracting unit 220 that extracts the feature of the general pixel will be described.

The sectional shape information extracting unit 220, as shown in FIG. 3, compares the brightness value of the general pixel which is the information extraction target pixel TP with the brightness value of the neighbor pixel NP adjacent to the general pixel to extract the number of neighbor pixels having brightness values larger than the brightness value of the general pixel and the number of neighbor pixels having brightness values smaller than the brightness value of the general pixel as the feature of the information extraction target pixel TP according to the comparison result.

Next, as a detailed example, an operation of the sectional shape information extracting unit 220 that extracts the feature of the corner pixel will be described.

The sectional shape information extracting unit 220 compares the brightness value of the corner pixel with the brightness value of the neighbor pixel adjacent to the corner pixel to, when the number of neighbor pixels having brightness values larger than the brightness value of the corner pixel is larger than the number of neighbor pixels having brightness values smaller than the brightness value of the corner pixel according to the comparison result, classify the corresponding corner pixel as a type 1 corner. Contrary to this, when the number of neighbor pixels having brightness values larger than the brightness value of the corner pixel is smaller than the number of neighbor pixels having brightness values smaller than the brightness value of the corner pixel according to the comparison result, the sectional shape information extracting unit 220 may classify the corresponding corner pixel as a type 2 corner.

Next, as a detailed example, an operation of the sectional shape information extracting unit 220 that extracts the feature of the edge pixel will be described.

The sectional shape information extracting unit 220 calculates a difference (hereinafter, referred to as ‘edge power’) between the brightness value of the edge pixel and the brightness value of the neighbor pixel adjacent thereto and directionality of the edge, and extracts the power and direction of the edge as the feature of the edge pixel. Herein, the edge direction as a direction in which the brightness value markedly varies may be, for example, any one of 8 directions as shown in FIG. 4. In this case, the sectional shape information extracting unit 220 may quantize and store the edge direction as m bits. When all 8 directions are regarded as different directions, m may be 3 and when directions such as (\textcircled{1},\textcircled{5}), (\textcircled{2},\textcircled{6}), (\textcircled{4},\textcircled{8}), and (\textcircled{3},\textcircled{7}) of FIG. 4 that have an angular difference of 180 degrees are regarded as one direction, m may be 2. The directionality of the edge may be calculated by using the known various edge detection methods. Further, the sectional shape information extracting unit 220 may quantize an edge power value as n bit. For example, n may be 2 or 3.

The global shape information extracting unit 240 may extract a feature of the global image (or global shape information) from the corner pixel and the edge pixel (S240).

For example, the global shape information extracting unit 240 may acquire a ratio of a principal axis acquired by using a covariance matrix of coordinates of corner pixels. After the global shape information extracting unit 240 acquires the following covariance matrix C by using coordinate values x,y in each image of all corner pixels, the type 1 corner pixels, the type 2 corner pixels, and the edge pixels that are detected by the sectional shape information extracting unit 220 and acquires the principal axis by using the C, it acquires a ratio value of the principal axis as shown in the following equation. Accordingly, with the embodiment of the present invention, four values of ratio of principal axes (or four PAR values) can be acquired. Three values of ratio of principal axes (or three PAR values) can be acquired in the case in which the edge pixel is excluded. In the following equation, n represents the number of pixels depending on each of a corner or edge. E(x) and E(y) may represent an average value of an x coordinate and an average value of a y coordinate of the corner pixels or the edge pixels, respectively.

$$C = ( \begin{matrix}{C}_{xx} & {C}_{xy} \\ {C}_{yx} & {C}_{yy}\end{matrix} ) E ( x ) = \begin{matrix}\frac{\sum x}{n} , E ( y ) = \frac{\sum y}{n} \\ \begin{matrix}{C}_{xx} = \frac{\sum {( x - E ( x ) )}^{2}}{n} , {C}_{yy} = \frac{\sum {( y - E ( y ) )}^{2}}{n} , \\ {C}_{xy} = {C}_{yx} = E ( ( x - E ( x ) ( y - E ( y ) )\end{matrix}\end{matrix}$$

$$P A R ( principal axis ratio ) = \frac{{c}_{yy} + {c}_{xx} - \sqrt{{( {c}_{yy} + {c}_{xx} )}^{2} - 4 ( {c}_{xx} {c}_{yy} - {c}_{xy}^{2} )}}{{c}_{yy} + {c}_{xx} + \sqrt{{( {c}_{yy} + {c}_{xx} )}^{2} - 4 ( {c}_{xx} {c}_{yy} - {c}_{xy}^{2} )}}$$

Further, the global shape information extracting unit 240 may acquire two eigen vectors from the covariance matrix and an angle which each vector forms with an x axis, etc. Herein, a ratio of two eigen vectors is equal to the principal axis ratio (PAR).

Meanwhile, a predetermined relationship between the direction of the edge extracted by the sectional shape information extracting unit 220 and the principal axis extracted by the global shape information extracting unit 240, for example, an angle therebetween is determined as shown in FIG. 5A. If the image pivots, both the principal axis and the edge directions pivots similarly as shown in FIG. 5B. That is, although the image pivots, a relationship between the principal axis and the edge directionality, for example, a relative angle therebetween is maintained similarly. Accordingly, the relationship between the principal axis and the edge directionality may be used as a feature configuring a shape descriptor to be described below. Further, the above-mentioned principal axis ratio may also be used as the feature configuring the shape descriptor.

Alternately, a ratio of the number of type 1 corner pixels and the number of type 2 corner pixels in the number of all the corner pixels may also be used as the global shape information.

According to yet another exemplary embodiment of the present invention, the global shape information extracting unit 240 may acquire a centroid of coordinate values of all corner pixels, the type 1 corner pixel, and the type 2 corner pixel and acquire length ratios, angles, etc. of a triangle formed by three points as the global shape information. Alternately, when a circle having a radius of r from the centroid of the coordinates is formed, the global shape information extracting unit 240 may extract ratios of the type 1 corner pixel and the type 2 corner pixel among corner pixels included in the circle.

Besides, the global shape information extractor 240 may acquire principal component analysis (PCA), fisher linear discriminant (FLD), circular variance, etc. by using the corner pixels and the edge pixels.

Next, a shape descriptor configuring section 300 configures the shape descriptor by using the features acquired by the sectional shape information extracting unit 220 and the global shape information extracting unit 240 (S250).

The shape descriptor configuring section 300, for example, may configure a shape descriptor of a bit stream of k bits (4≦k≦11) by using the features extracted from the corner pixel and the general pixel as shown in FIG. 6. According to an embodiment of the present invention, in the case of k=5, upper 2 bits among bit streams of 5 bits represent a pixel index (e.g., 11, 10, 00) meaning the type 1 corner pixel, the type 2 corner pixel, or the general pixel. Lower 3 bits as the feature extracted by the sectional shape information extracting unit 220 may represent a result of comparing the brightness value of the information extraction target pixel with the brightness value of the neighbor pixel. For example, the lower 3 bits may express the number of pixels having brightness values larger than the brightness of the information extraction target pixel. Alternately, as an example different from the example of FIG. 5, when the shape descriptor is configured by bit streams of 8 bits, 3 bits representing the number of pixels having brightness values smaller than the brightness value of the information extraction target pixel may be expressed by being added to the bit streams shown in FIG. 5.

Alternately, the shape descriptor configuring section 300, for example, may configure a shape descriptor of the bit streams of 5 bits by using the feature extracted from the edge pixel as shown in FIG. 6. Upper 2 bits among the bit streams of 5 bits may represent whether or not the corresponding pixel is the edge pixel, lower 2 bits may represent the edge directionality, and the last 1 bit may represent the edge power. However, at this time, the edge directionality may be relative directionality with respect to the principal axis as described above with reference to FIGS. 5A and 5B. As such, a shape map in which k bits are allocated to each pixel is configured.

Shape descriptors shown in FIGS. 6 and 7 are exemplary and as described above, the shape descriptor may be configured to express the features extracted by the sectional shape information extracting unit 220 and the global shape information extracting unit 240. For example, the shape descriptor configuring section 300 configures a histogram by using the shape map and may configure the histogram as the shape descriptor by using the feature acquired by the global shape information extracting unit 240.

Next, the image matching section 400 performs image matching by comparing the shape descriptor extracted from the query image with a previously extracted shape descriptor in a DB (S260). In the image matching, a difference between the shape of the descriptor generated from the query image and the features of the image stored in the DB is calculated by using a sum of difference (SAD), a sum of squared distortion (SSD), etc. so as to match the images. The images are arranged in a similarity order by matching the query image and the image stored in the DB with each other.

Lastly, the retrieval result outputting section 500 outputs the images arranged in the similarity order calculated by the image matching section 400 on a retrieval result window (S270).

A program that executes the method according to the embodiment of the present invention may be stored in a computer-readable recording medium.

It will be understood to those skilled in the art that the embodiments described can be modified into various forms without changing technical spirits or essential features. Accordingly, the embodiments described herein are provided by way of example only and should not be construed as being limited. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A content based image retrieval apparatus, comprising:
a query image converter converting an inputted query image to a black/white image and normalizing the size of the query image;
a shape information extractor extracting a feature on the basis of brightness values in all pixels of the normalized black/white query image; and
a shape descriptor configuring section configuring a shape descriptor for each pixel by using the feature.

2. The content based image retrieval apparatus according to claim 1, wherein the shape information extractor includes:
a sectional shape information extracting unit detecting a corner pixel, an edge pixel, and a general pixel among all the pixels and extracting the features by using the brightness values with respect to the corner pixel, the edge pixel, and the general pixel; and
a global shape information extracting unit extracting features of a global image from the detected corner pixel and edge pixel.

3. The content based image retrieval apparatus according to claim 2, wherein the sectional shape information extracting unit extracts a result of comparing the brightness value of the corner pixel with the a brightness value of a neighbor pixel adjacent to the corner pixel as the feature of the corner pixel.

4. The content based image retrieval apparatus according to claim 2, wherein the sectional shape information extracting unit extracts a direction of the edge pixel, and a difference between the brightness value of the edge pixel, and a brightness of a neighbor pixel adjacent to the edge pixel as the features of the edge pixel.

5. The content based image retrieval apparatus according to claim 2, wherein the sectional shape information extracting unit extracts a result of comparing the brightness value of the general pixel with a brightness value of a neighbor pixel adjacent to the general pixel as the feature of the general pixel.

6. The content based image retrieval apparatus according to claim 2, wherein the global shape information extracting unit calculates a covariance matrix by using coordinates of the corner pixel and the edge pixel in the normalized black/white query image and calculates a ratio of a principal axis by using the covariance matrix to extract the calculated principal axis ratio as the feature of the global image.

7. The content based image retrieval apparatus according to claim 6, wherein the sectional shape information extracting unit extracts the direction of the edge pixel as the feature of the edge pixel and the shape descriptor configuring section configures a shape descriptor of the edge pixel by using a relative direction of the edge pixel with respect to the principal axis.

8. The content based image retrieval apparatus according to claim 2, wherein the global shape information extracting unit extracts the feature of the global image from coordinates of the corner pixel, the edge pixel, and the general pixel in the normalized black/white query image, wherein the feature of the global image comprises at least one of a centroid of the coordinates, a ratio of each pixel in a circle having a predetermined radius around the centroid, and a length ratio of a quadrangle or a triangle formed by the coordinates and an inner angle of the quadrangle or the triangle.

9. The content based image retrieval apparatus according to claim 1, further comprising:
an image matching section retrieving an image by calculating a similarity between the shape descriptor and images stored in a database; and
a retrieval result outputting section outputting the image retrieved depending on the calculated similarity.

10. A content based image retrieval method, comprising:
extracting features of pixels configuring an inputted query image by using brightness values of the pixels;
configuring shape descriptors of the pixels by using the features; and
retrieving the image by using the shape descriptors.

11. The content based image retrieval method according to claim 10, wherein the extracting includes:
comparing the brightness value of each pixel with a brightness value of a neighbor pixel adjacent to each pixel; and
extracting a feature of a target pixel on the basis of the comparison result.

12. The content based image retrieval method according to claim 11, wherein the extracting the feature on the basis of the comparison result extracts the number of neighbor pixels having brightness values larger than the brightness value of the target pixel and the number of neighbor pixels having brightness values equal to or smaller than the brightness value of the target pixel as the feature of the target pixel.

13. The content based image retrieval method according to claim 10, wherein the extracting includes:
classifying the pixels configuring the query image into a corner pixel, an edge pixel, and a general pixel;
extracting the feature of the corner pixel by comparing the brightness value of the corner pixel with a brightness value of a first neighbor pixel surrounding the corner pixel;
extracting the feature of the corner pixel by comparing the brightness value of the edge pixel with a brightness value of a second neighbor pixel surrounding the edge pixel; and
extracting the feature of the general pixel by comparing the brightness value of the general pixel with a brightness value of a third neighbor pixel surrounding the general pixel.

14. The content based image retrieval method according to claim 13, wherein the configuring includes:
configuring a shape descriptor of the corner pixel by using the feature of the corner pixel;
configuring a shape descriptor of the edge pixel by using the feature of the edge pixel; and
configuring a shape descriptor of the general pixel by using the feature of the general pixel.

15. The content based image retrieval method according to claim 14, wherein the extracting the feature of the edge pixel includes a direction of the edge pixel, and
the configuring the descriptor of the edge pixel includes:
calculating a covariance matrix by using coordinates of the corner pixel and the edge pixel;
calculating a principal axis from the covariance matrix; and
configuring the shape descriptor of the edge pixel by using a relationship between the principal axis and the direction of the edge pixel.

16. A content based image retrieval method, comprising:
converting an inputted query image to a black/white image and normalizing the size of the query image;
detecting a corner pixel, an edge pixel, and a general pixel among all pixels configuring the normalized black/white query image;
extracting sectional features on the basis of brightness values of the corner pixel, the edge pixel, and the general pixel;
extracting a global feature of the image from at least one of the corner pixel, the edge pixel, and the general pixel;
configuring a shape descriptor by using the sectional feature and the global feature; and
retrieving the image by using the shape descriptor.

17. The content based image retrieval method according to claim 16, wherein the extracting sectional features includes extracting the number of first neighbor pixels having brightness values larger than the brightness value of the corner pixel among neighbor pixels surrounding the corner pixel, the number of second neighbor pixels having brightness values smaller than the brightness value of the corner pixel, and a size relationship between the numbers of the first and second neighbor pixels as the feature of the corner pixel.

18. The content based image retrieval method according to claim 17, wherein the extracting sectional features further includes extracting a directionality of the edge pixel, and a difference between the brightness value of the edge pixel, and a brightness of a neighbor pixel adjacent to the edge pixel as the features of the edge pixel.

19. The content based image retrieval method according to claim 18, wherein the extracting sectional features further includes extracting the number of first neighbor pixels having brightness values larger than the brightness value of the general pixel among neighbor pixels surrounding the general pixel, the number of second neighbor pixels having brightness values smaller than the brightness value of the general pixel, and a size relationship between the numbers of the first and second neighbor pixels as the feature of the general pixel.

20. The content based image retrieval method according to claim 19, wherein the configuring a shape descriptor includes:
calculating a covariance matrix by using coordinates of the corner pixel and the edge pixel in the normalized black/white query image; and
calculating a principal axis and a ratio of the principal axis from the covariance matrix; and
calculating a relative direction of the edge pixel to the principal axis from the directionality extracted by the edge pixel and configuring a shape descriptor of the edge pixel by using the relative directionality and the ratio of the principal axis.
